(19) United States
(12) Patent Application Publication
(10) Pub. No.: US 2025/0021635 A1
(43) Pub. Date: Jan. 16, 2025

(54) POWER TRANSMISSION CONTROL DEVICE

(71) Applicant: TOYOTA JIDOSHA KABUSHIKI KAISHA, Aichi-ken (JP)

(72) Inventor: Takahiro UEKI, Tokyo (JP)

(21) Appl. No.: 18/674,919

(22) Filed: May 27, 2024

(30) Foreign Application Priority Data
Jul. 11, 2023 (JP) 2023-113855

(51) Int. Cl. G06F 21/33; B60L 53/68

(52) U.S. Cl. CPC G06F 21/33; B60L 53/68

(57) ABSTRACT

The charging control device comprises a storage device for recording a plurality of digital certificates relating to charging. Further, the charging control device includes a processor that selects a digital certificate that matches the charging station among the plurality of digital certificates based on predetermined information (identification information or history information) regarding the charging station in which charging is performed with electrified vehicle. The communication device sends the selected digital certificate to the charging station.

### CROSS-REFERENCE TO RELATED APPLICATION

This application claims priority to Japanese Patent Application No. 2023-113855 filed on Jul. 11, 2023, incorporated herein by reference in its entirety.

### BACKGROUND

### 1. Technical Field

The present disclosure relates to a power transmission control device.

### 2. Description of Related Art

Japanese Unexamined Patent Application Publication No. 2022-061185 (JP 2022-061185 A) discloses a vehicle including an in-vehicle processing unit that acquires charging-side information including identification information associated with a charging device and address information on a server device that performs charging authentication. When the charging-side information is acquired by the vehicle, a connection between a vehicle-side authentication unit (user terminal) and the server device is established, and an authentication process is started.

### SUMMARY

Here, although not specified in JP 2022-061185 A, a charging process between the vehicle and the charging device is occasionally executed when an appropriate piece of contract certificate information, among a plurality of pieces of contract certificate information stored in the vehicle, is transmitted from the vehicle to the charging device. That is, a charging process (power transmission) cannot be executed when an inappropriate piece of contract certificate information is transmitted from the vehicle (electrified vehicle) to the charging device (power stand).

The present disclosure has been made in order to address the above-described issue, and an object of the present disclosure is to provide a power transmission control device capable of suppressing the occurrence of a case where power transmission between an electrified vehicle with a plurality of pieces of contract certificate information and a power stand cannot be executed.

An aspect of the present disclosure provides
a power transmission control device that controls power transmission including at least one of charging and discharging of a secondary battery of an electrified vehicle. The power transmission control device includes:
a storage unit that stores a plurality of pieces of contract certificate information about the power transmission; an acquisition unit that acquires predetermined information about a power stand that executes the power transmission with the electrified vehicle;
a selection unit that selects a piece of contract certificate information that suits the power stand, among the pieces of contract certificate information, based on the acquired predetermined information; and a transmission unit that transmits the selected piece of contract certificate information to the power stand.

In the power transmission control device according to the aspect of the present disclosure, as described above, a piece of contract certificate information that suits the power stand is selected among the pieces of contract certificate information, and the selected piece of contract certificate information is transmitted to the power stand. Accordingly, it is possible to suppress a piece of contract certificate information that does not suit the power stand being transmitted to the power stand. As a result, it is possible to suppress the occurrence of a case where power transmission between the electrified vehicle with the plurality of pieces of contract certificate information and the power stand cannot be executed.

In the power transmission control device according to the above aspect, preferably,
when the power stand is set as a destination, the acquisition unit acquires identification information on the power stand set as the destination as the predetermined information.

The selection unit may select a piece of contract certificate information that suits the power stand set as the destination based on the identification information.

According to this configuration, it is possible to suppress the occurrence of a case where power transmission cannot be executed at the power stand set as the destination.

In the power transmission control device according to the above aspect, preferably,
when a distance between the electrified vehicle and the power stand is within a predetermined distance, the acquisition unit acquires identification information on the power stand located within the predetermined distance as the predetermined information.

The selection unit may select a piece of contract certificate information that suits the power stand located within the predetermined distance based on the identification information.

According to this configuration, it is possible to suppress the occurrence of a case where power transmission cannot be executed at the power stand located within the predetermined distance.

In the power transmission control device according to the above aspect, preferably,
when a distance between the electrified vehicle and the power stand is within a predetermined distance, the acquisition unit acquires history information on a past history of the power transmission at the power stand located within the predetermined distance as the predetermined information.

The selection unit may select a piece of contract certificate information that suits the power stand located within the predetermined distance based on the history information.

According to this configuration, it is possible to suppress the occurrence of a case where power transmission cannot be executed at the power stand located within the predetermined distance by using the history information, even in the absence of the identification information on the power stand.

In the power transmission control device according to the above aspect, preferably,
when a distance between the electrified vehicle and the power stand is within a predetermined distance and identification information on the power stand located within the predetermined distance is obtainable by the acquisition unit in a situation in which the power stand is not set as a destination, the selection unit may select a piece of contract certificate information that suits the power stand located within the predetermined distance based on the identification information.

When the distance between the electrified vehicle and the power stand is within the predetermined distance and the identification information is not obtainable by the acquisition unit in a situation in which the power stand is not set as the destination, the selection unit may select a piece of contract certificate information that suits the power stand located within the predetermined distance using history information on a past history of the power transmission at the power stand located within the predetermined distance.

According to this configuration, it is possible to suppress the occurrence of a case where power transmission cannot be executed at the power stand located within the predetermined distance by using the identification information or the history information, even when the power stand is not set as the destination.

In the power transmission control device in which a piece of contract certificate information is selected based on the identification information,
the identification information may include information on a power company with which the power stand is affiliated.

According to this configuration, it is possible to transmit a piece of contract certificate information that suits the power company with which the power stand is affiliated to the power stand.

According to the present disclosure, it is possible to suppress the occurrence of a case where power transmission between the electrified vehicle with the plurality of pieces of contract certificate information and the power stand cannot be executed.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram illustrating an electrified vehicle equipped with a charge control device, a charge station, and servers according to an embodiment;

FIG. 2 is a diagram illustrating an example of contents of a digital certificate;

FIG. 3 is a diagram illustrating a charging station and a power company;

FIG. 4 is a sequence diagram illustrating control of a charging system according to one embodiment;

FIG. 5 is a first view of a HMI device according to one embodiment;

FIG. 6 is a second view of a HMI device according to one embodiment; and

FIG. 7 is a sequential diagram illustrating a detailed S30 of FIG. 4.

### DETAILED DESCRIPTION OF EMBODIMENTS

Hereinafter, embodiments of the present disclosure will be described in detail with reference to the drawings. It should be noted that the same or corresponding portions in the drawings are designated by the same reference signs and repetitive description will be omitted.

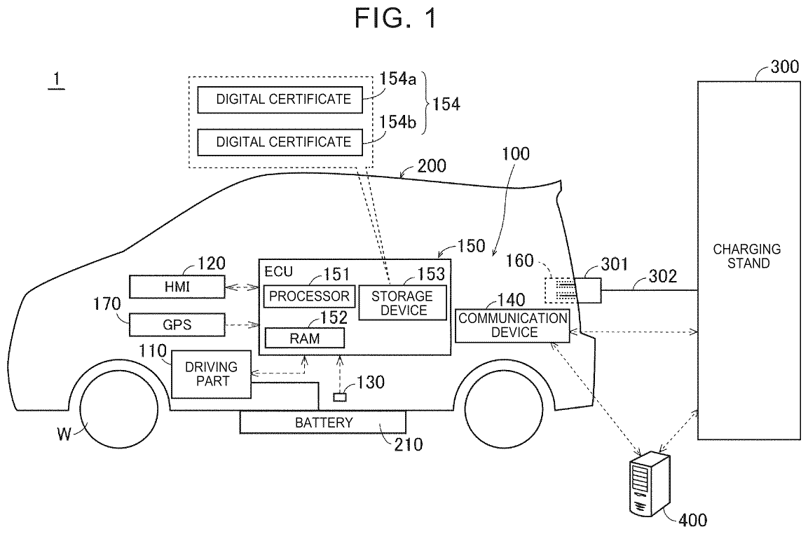

FIG. 1 is a diagram schematically illustrating a configuration of a charging system 1 according to the present embodiment. The charging system 1 includes an electrified vehicle 200, a charging station 300, and a server 400. Note that the charging station 300 is an example of a “power station” of the present disclosure.

Electrified vehicle 200 is configured to perform PnC charging (charging in which the user is authenticated in response to the charging connector being connected to the vehicle) with the charging station 300.

The server 400 manages external charging (PnC charging) between electrified vehicle 200 and the charging station 300. The server 400 communicates with each of electrified vehicle 200 and charge stations 300. Note that the external charge (PnC charge) is an exemplary “power transfer” of the present disclosure.

Electrified vehicle 200 includes a battery 210 that stores electric power for

traveling. Electrified vehicle 200 is configured to be able to travel using the electric power stored in the battery 210. In the present embodiment, electrified vehicle 200 is a battery electric vehicle (BEV) that does not include an engine (internal combustion engine). Electrified vehicle 200 may be an engine-equipped hybrid electric vehicle (HEV) or plug-in hybrid electric vehicle (PHEV). The battery 210 is an example of a “secondary battery” of the present disclosure.

Electrified vehicle 200 further includes a travel driver 110, a Human Machine Interface (HMI) device 120, a monitoring module 130, a communication device 140, a control device (ECU) 150, inlet 160, GPS module 170, and drive wheels W.

Electrified vehicle 200 is also equipped with a charge control device 100 that controls charging of the battery 210. The charge control device 100 includes a monitoring module 130, a communication device 140, and a ECU 150. Note that the charge control device 100 is an example of a “power transmission control device” of the present disclosure.

The travel driver 110 includes a Power Control Unit (PCU) and a Motor Generator (MG) (not shown), and is configured to use the electric power stored in the battery 210 to travel electrified vehicle 200.

HMI device 120 includes an inputting device and a displaying device. HMI device 120 may include a touch panel display.

The monitoring module 130 includes various sensors that detect the status (e.g., voltage, current, and temperature) of the battery 210, and outputs the detected data to ECU 150. The monitoring module 130 may be a Battery Management System (BMS) that further includes a State Of Charge (SOC) estimation function, a State of Health (SOH) estimation function, a cell-voltage equalization function, a diagnostic function, and a communication function in addition to the sensor function.

The communication device 140 communicates with each of the charging station 300 and the server 400. The communication device 140 may include a Data Communication Module (DCM) or a fifth-generation mobile communication I/F (5G). Note that the communication device 140 is an example of the “acquisition unit” and the “transmission unit” of the present disclosure.

ECU 150 is configured to perform charge-control and discharge-control of the battery 210. ECU 150 includes a processor 151, a Random Access Memory (RAM) 152, and a storage device 153. Note that the processor 151 is an example of the “selection unit” and the “acquisition unit” of the present disclosure. The storage device 153 is an example of a “storage unit” of the present disclosure.

ECU 150 may be a computer. The processor 151 may be a Central Processing Unit (CPU). RAM 152 functions as working memories for temporarily storing data to be processed by the processor 151.

The storage device 153 is configured to store stored information. In addition to the program, information (for example, a map, a mathematical expression, and various parameters) used in the program is stored in the storage device 153. The processor 151 executes programs stored in the storage device 153 to perform various types of control in ECU 150.

The storage device 153 stores a digital certificate 154. The digital certificate 154 includes a digital certificate 154a and a digital certificate 154b. ECU 150 (processor 151) is capable of executing a process of writing the digital certificate 154 to the storage device 153. Here, the digital certificate 154 includes, for example, an Original Equipment Manufacturer (OEM) certificate and a charge contract certificate. Note that the charge contract certificate certifies the contract content concluded between the mobility operator Mobility Operator (MO) providing the charge service, the electric power company, and the user of electrified vehicle 200. Note that the digital certificate (154, 154a, 154b) is an example of the “contract certificate information” of the present disclosure.

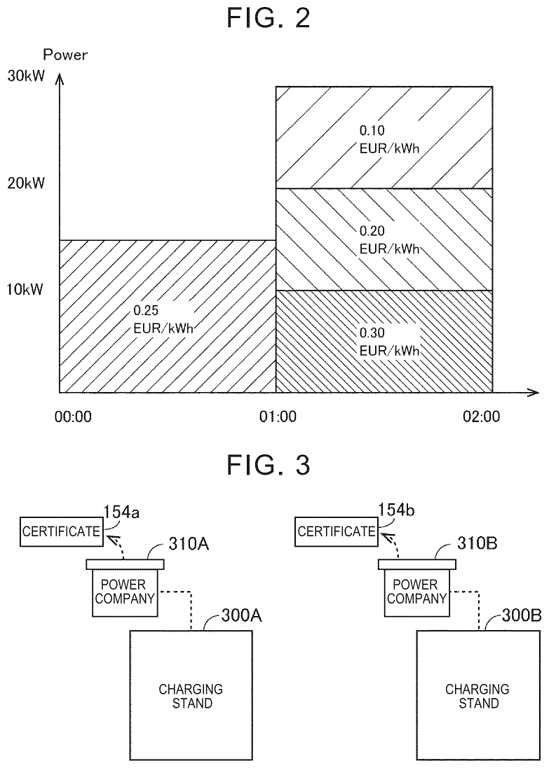

In an example illustrated in FIG. 2, the digital certificate 154 includes the charge rate determined by the time and the charge power. FIG. 2 is an example of information included in a digital certificate 154a. The digital certificate 154a includes information indicating that the upper limit of the charge power amount is 15 kW and the charge rate is 0.25 EUR/kWh from 0:00 a.m. to 1:00 a.m. In addition, the digital certificate 154a includes, between 1:00 a.m. and 2:00 a.m., a charge rate is 0.30 EUR/kWh until the charge power amount is 10 KW, a charge rate is 0.20 EUR/kWh from 10 kW to 20 kWh, and a charge rate is 0.10 EUR/kWh from 20 kW to 30 kWh. Note that the information included in the digital certificate 154a is not limited to the example shown in of FIG. 2.

In addition, the digital certificate 154 includes information associated with the fee system in FIG. 2. The information includes, for example, vehicle information (VIN) of electrified vehicle 200, personal information of the user of electrified vehicle 200, and card information used to pay a charge fee. An expiration date is set in the digital certificate 154. ECU 150 controls the charge authenticated by the digital certificate 154. If the digital certificate 154 has expired, the digital certificate 154 needs to be updated.

In addition, the digital certificate 154 includes information of an electric power company that is an issuing source. Specifically, the digital certificate 154a includes information indicating that the digital certificate is issued from the electric power company 310A (see FIG. 3). In addition, the digital certificate 154b includes information indicating that the digital certificate is issued from the electric power company 310B (see FIG. 3). In the present embodiment, it is assumed that the charging station 300A and the charging station 300B (both of which are shown in FIG. 3) are respectively associated with the electric power company 310A and the electric power company 310B. Each of the charging station 300A and the charging station 300B is an exemplary “power station” of the present disclosure.

The processor 151 can execute a process of switching the digital certificate 154 used in the external charging. Specifically, the processor 151 reads the digital certificate 154 to be used from the storage device 153 when electrified vehicle 200 performs the external charge. Electrified vehicle 200 transmits a digital certificate 154a to the charging station 300 through the communication device 140 when, for example, a digital certificate 154a is being read as the digital certificate 154 to be used. When the digital certificate 154 sent to the charging station 300 is compatible with the charging station 300, external charging is performed between electrified vehicle 200 and the charging station 300. The charging station 300A is compatible with a digital certificate 154a issued by the electric power company 310A that is affiliated with the charging station 300A. The charging station 300B is fitted with a digital certificate 154b issued by a utility 310B affiliated with the charging station 300B.

The inlet 160 is configured such that the charge connector 301 of the charging station 300 can be inserted. The charge connector 301 is provided at the distal end of the charge cable 302 attached to the charging station 300. Electrified vehicle 200 is electrically connected to the charging station 300 by inserting the charge connector 301 into the inlet 160 This allows power to be exchanged between the charging station 300 and electrified vehicle 200.

GPS module 170 acquires information (GPS information) indicating the present position of electrified vehicle 200 based on signals from the plurality of satellites, and outputs GPS information to the processor 151. Note that electrified vehicle 200 may include a beacon receiver (not shown) in place of or in addition to GPS module 170.

Here, in a conventional system, an inappropriate digital certificate 154 may be transmitted from the vehicle to the power station. In this case, the charging process cannot be executed.

In the present embodiment, the communication device 140 of electrified vehicle 200 acquires the identification information related to the charging station 300 by communication. The identification information includes information of an electric power company to which the charging station 300 is affiliated. Further, the processor 151 acquires historical data of the previous external charge (PnC charge) in the charging station 300. The history information is stored in the storage device 153. Note that each of the information (identification information) and the history information of the electric power company is an example of “predetermined information” of the present disclosure.

The processor 151 selects the digital certificate 154 that matches the charging station 300 (to be externally charged) among the plurality of digital certificates 154 recorded in the storage device 153 based on the information of the electric power company acquired by the communication device 140 (hereinafter, may be referred to as only identification information) or the history information acquired from the storage device 153. The communication device 140 then transmits the digital certificate 154 selected by the processor 151 to the charging station 300 where external charging is performed.

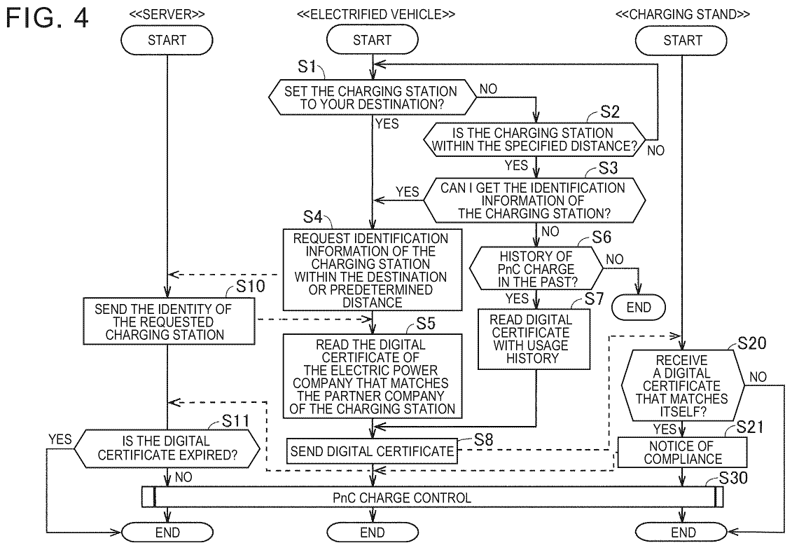

As a result, the digital certificate 154 compatible with the charging station 300 can be easily transmitted to the charging station 300. As a result, external charging can be easily performed. A specific control will be described with reference to a flow chart shown in FIG. 4.

### Sequence Control of Charging System

FIG. 4 is a sequence diagram illustrating sequence control of the charging system 1 including electrified vehicle 200, the charging station 300, and the server 400.

In S1, ECU150 of electrified vehicle 200 (processor 151) determines whether the charging station 300 is set to a destination. When the charging station 300 is set as the destination (Yes in S1), the process proceeds to S4. If the charging station 300 is not set to the destination (No in S1), the process proceeds to S2.

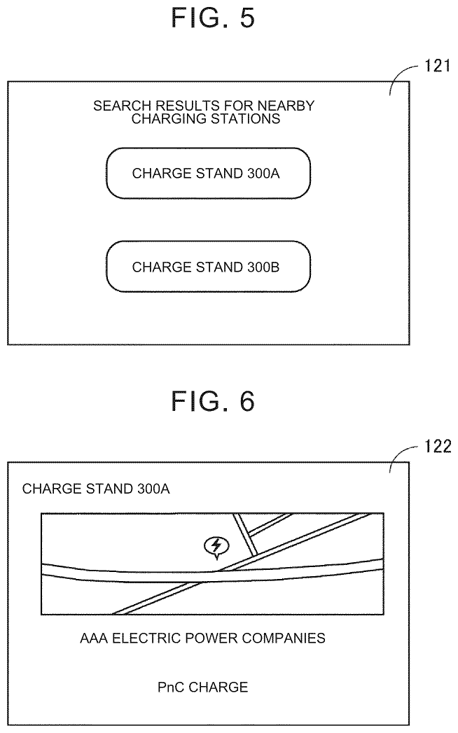

When the process of searching the charging station 300 is performed in HMI device 120, 121 of HMI device 120 (see FIG. 5), the charging station 300 in the vicinity of electrified vehicle 200 is listed. When one of the charging stations 300 displayed on the display 121 is selected, the selected charging station 300 may be set as a destination.

In S2, the processor 151 determines whether the charging station 300 is within a predetermined range (e.g., within a 100 m) of electrified vehicle 200. The position information of the charging station 300 may be stored in the storage device 153 or may be acquired from the server 400 through the communication device 140. When the charging station 300 is within the predetermined range (Yes in S2), the process proceeds to S3. If the charging station 300 is not within the predetermined range (No in S2), the process returns to S1. It should be noted that the presence of the charging station 300 within a predetermined range includes a state in which electrified vehicle 200 has arrived at the charging station 300.

In S3, the processor 151 determines whether or not information (identification information) of a power company associated with the charging station 300 determined to be within a predetermined range in S2 can be acquired. For example, when electrified vehicle 200 is unable to communicate with the charging station 300, or when the identification information of the charging station 300 is not stored in the server 400, the identification information is unavailable. If the identity of the charging station 300 is obtainable (Yes in S3), the process proceeds to S4. If the identity of the charging station 300 is not obtainable (No in S3), the process proceeds to S6.

In S4, the processor 151 requests the server 400 to identify the charging station 300 set at the destination in S1 or the charging station 300 determined to be within a predetermined range in S2. The processor 151 may make the request to the charging station 300.

For example, when the charging station 300A is selected on the display 121 shown in FIG. 5, it is determined that the charging station 300A is set as the destination, and a signal requesting the identification information of the charging station 300A is transmitted from electrified vehicle 200 to the server 400. In response to the charging station 300A falling within the predetermined range of electrified vehicle 200, a signal requesting the identification information of the charging station 300A is transmitted from electrified vehicle 200 to the server 400.

In S10, the server 400 transmits the requested identity of the charging station 300 to electrified vehicle 200 in response to a request signal transmitted from electrified vehicle 200 in S4. As a result, HMI device 120 of electrified vehicle 200 displays a picture 122 including the identity of the charging station 300 (see FIG. 6). In the embodiment shown in FIG. 6, a map showing the locations of the charging station 300A is displayed, indicating that the company affiliated with the charging station 300A is a AAA power company, that the charging station 300A is compatible with PnC charging, and that the charging station 300A is located.

The processor 151 of electrified vehicle 200 that has received the identity transmitted from the server 400 in S10 retrieves the appropriate digital certificate 154 for external charging in S5. Specifically, the processor 151 reads the digital certificate 154 issued by the electric power company (AAA electric power company in FIG. 6) that cooperates with the charging station 300 based on the identification information transmitted from the server 400 in S10. Note that the digital certificate 154 issued by the affiliated company of the electric power company that cooperates with the charging station 300 may be read. After S5, the process proceeds to S8.

On the other hand, in S6, the processor 151 determines whether or not there is a history of PnC charging with the charging station 300 determined to be within the predetermined range in S2. Specifically, the processor 151 performs the above determination by reading the history of executing PnC charge stored in the storage device 153. If there is a history (Yes in S6), the process proceeds to S7. If there is no history (No in S6), the process ends.

In S7, the processor 151 selects a digital certificate 154 to retrieve based on the history in S6. Specifically, the digital certificate 154 used in PnC charge corresponding to the history is read out. Thereafter, the process proceeds to S8.

In S8, the processor 151 transmits the digital certificate 154 retrieved in S5 or S7 to the charging station 300 through the communication device 140. Thereafter, the process proceeds to S30. Note that, in S5, when the compatible digital certificate 154 is not recorded in the storage device 153, for example, the digital certificate 154 having the highest priority among the digital certificates 154 recorded in the storage device 153 may be transmitted to the charging station 300.

In S20, the charging station 300 determines whether the digital certificate 154 sent from electrified vehicle 200 in S8 is a digital certificate 154 that matches itself. Specifically, the charging station 300 determines whether or not the digital certificate 154 issued by the electric power company that is affiliated with the charging station has been received. If a digital certificate 154 matching the charging station 300 is received (Yes in S20), the process proceeds to S21. If a digital certificate 154 that matches the charging station 300 has not been received (No in S20), the process ends.

In S21, the charging station 300 notifies electrified vehicle 200 and server 400 that the digital certificate 154 is compliant in S20. Note that the server 400 may be notified from electrified vehicle 200. Thereafter, the process proceeds to S30.

In S11, the server 400 determines whether the expiration date of the digital certificate 154 determined in S20 to be compatible with the charging station 300 has expired. If the expiration date has expired (Yes in S11), the process ends. If the expiration date has not expired (No in S11), the process proceeds to S30.

In S30, electrified vehicle 200, the charging station 300, and the server 400 performs PnC charging control.

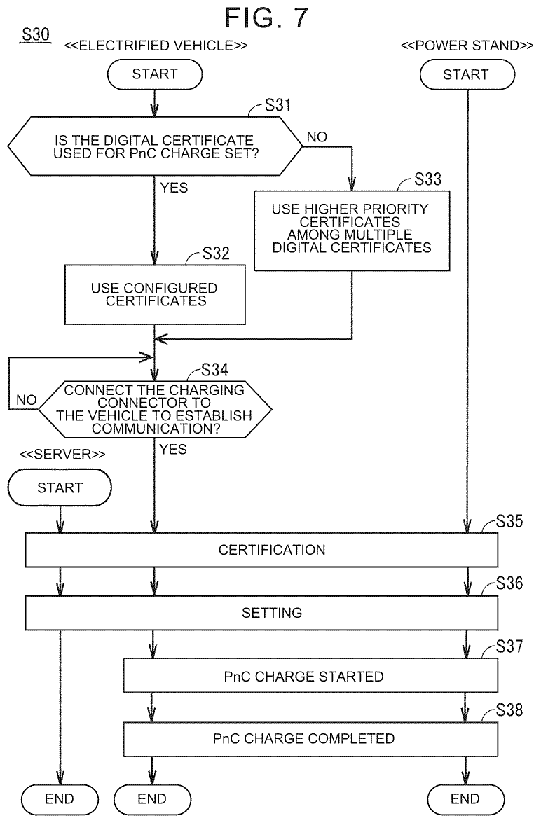

FIG. 7 is a diagram illustrating a specific sequence of S30 in FIGS. 4. S31 to S33 in FIG. 7 are executed when a plurality of compatible digital certificates 154 are read out in S5 in FIG. 4.

In S31, electrified vehicle 200 processor 151 determines whether the digital certificate 154 used in PnC charge is set. In other words, it is determined whether the plurality of digital certificates 154 read in S5 of FIG. 4 include a digital certificate 154 that is set in advance by the user as a certificate to be used in PnC charge. If Yes in S31, the process proceeds to S32. If No in S31, the process proceeds to S33.

In S32, the processor 151 sets the digital certificate 154 that is set to be used for PnC charging as the digital certificate 154 used for PnC charging. Thereafter, the process proceeds to S34.

In S33, the processor 151 sets the digital certificate 154 having the highest priority among the plurality of digital certificates 154 read in S5 as the digital certificate 154 used for PnC charge. The priority of the digital certificate 154 is set in advance. Thereafter, the process proceeds to S34.

In S34, the processor 151 determines whether the charge connector 301 is connected to electrified vehicle 200 (inlet 160) and a secure communication link is established between electrified vehicle 200 and the charging station 300. If a communication link is established (Yes in S33), the process proceeds to S35. When the communication connection is not established (No in S33), S34 process is repeated until the communication connection is established. It should be noted that a communication connection is established between electrified vehicle 200 and the charging station 300 by using User Datagram Protocol (UDP), Transmission Control Protocol (TCP), and Transport Layer Security (TLS).

In S35, various types of authentications are performed between electrified vehicle 200 and the charging station 300. For example, processes such as identification (identification), data-verification (authentication), and authorization (authorization) are performed.

In S36, a setting is performed. For example, a target setting, a charge scheduling setting, or the like is executed.

In S37, a PnC charge between electrified vehicle 200 and the charging station 300 is performed. In S38, PnC charge is ended.

As described above, in the present embodiment, the charge control device 100 includes the processor 151 that selects the digital certificate 154 that matches the charging station 300 among the plurality of digital certificates 154 based on predetermined information (identification information and history information) regarding the charging station 300 in which external charging is performed with electrified vehicle 200. The communication device 140 transmits the selected digital certificate 154 to the charging station 300. Accordingly, the charge control device 100 can acquire the information of the digital certificate 154 that matches the charging station 300 in advance of the external charging. As a result, the digital certificate 154 conforming to the charging station 300 can be more reliably transmitted to the charging station 300 than in the case where the information of the digital certificate 154 conforming to the charging station 300 is not obtained in advance. As a result, external charging can be more reliably performed.

In addition, unlike the case where the user manually switches the digital certificate 154, since the appropriate digital certificate 154 is automatically set, the time and effort of the user can be reduced.

In the above-described embodiment, the control for setting (reading) the digital certificate 154 during external charging has been described, but the present disclosure is not limited to this. The same control as in the above embodiment may be executed when setting (reading) the digital certificate 154 at the time of external discharge (external power supply) instead of or in addition to the time of external charging. In this case, the external discharge (external power supply) is an example of “power transmission” of the present disclosure.

In the above embodiment, three determinations of whether or not the charging station 300 is set as the destination, whether or not the charging station 300 is located within a predetermined distance, and whether or not there is a history of charging (PnC charging) in the past are performed, but the present disclosure is not limited to this. Only one or two of the three determinations may be performed. Further, it is not necessary to determine whether or not the identity of the charging station 300 can be acquired (refer to S6 in FIG. 4).

In the above embodiment, the charge control device 100 is provided in electrified vehicle 200, but the present disclosure is not limited to this. The charge control device 100 may be provided in the server 400.

In the above embodiment, the charging system 1 is configured by electrified vehicle 200, the charging station 300, and the server 400. Electrified vehicle 200 and the charging station 300 may constitute a charging device.

In the above embodiment, an example in which the identification information of the charging station 300 is acquired from the charging station 300 or the server 400 has been described, but the present disclosure is not limited thereto. For example, the storage device 153 may store identification information of the charging station 300. In this case, the identification information stored in the storage device 153 is acquired (read) by the processor 151.

In the above-described embodiment, an example in which the history information of the external charging is stored in the storage device 153 has been described, but the present disclosure is not limited thereto. The history information may be stored in the server 400.

Note that the configurations of the above-described embodiment and the above-described modification examples may be combined with each other.

The embodiment disclosed herein should be considered as illustrative and not restrictive in all respects. The scope of the present disclosure is shown by the claims, rather than the above embodiments, and is intended to include all modifications within the meaning and the scope equivalent to those of the claims.

What is claimed is:

1. A power transmission control device that controls power transmission including at least one of charging and discharging of a secondary battery of an electrified vehicle, the power transmission control device comprising:
a storage unit that stores a plurality of pieces of contract certificate information about the power transmission;
an acquisition unit that acquires predetermined information about a power stand that executes the power transmission with the electrified vehicle;
a selection unit that selects a piece of contract certificate information that suits the power stand, among the pieces of contract certificate information, based on the acquired predetermined information; and
a transmission unit that transmits the selected piece of contract certificate information to the power stand.

2. The power transmission control device according to claim 1, wherein:
when the power stand is set as a destination, the acquisition unit acquires identification information on the power stand set as the destination as the predetermined information; and
the selection unit selects a piece of contract certificate information that suits the power stand set as the destination based on the identification information.

3. The power transmission control device according to claim 1, wherein:
when a distance between the electrified vehicle and the power stand is within a predetermined distance, the acquisition unit acquires identification information on the power stand located within the predetermined distance as the predetermined information; and
the selection unit selects a piece of contract certificate information that suits the power stand located within the predetermined distance based on the identification information.

4. The power transmission control device according to claim 1, wherein:
when a distance between the electrified vehicle and the power stand is within a predetermined distance, the acquisition unit acquires history information on a past history of the power transmission at the power stand located within the predetermined distance as the predetermined information; and
the selection unit selects a piece of contract certificate information that suits the power stand located within the predetermined distance based on the history information.

5. The power transmission control device according to claim 1, wherein
the selection unit is configured to:
when a distance between the electrified vehicle and the power stand is within a predetermined distance and identification information on the power stand located within the predetermined distance is obtainable by the acquisition unit in a situation in which the power stand is not set as a destination, select a piece of contract certificate information that suits the power stand located within the predetermined distance based on the identification information; and
when the distance between the electrified vehicle and the power stand is within the predetermined distance and the identification information is not obtainable by the acquisition unit in a situation in which the power stand is not set as the destination, select a piece of contract certificate information that suits the power stand located within the predetermined distance using history information on a past history of the power transmission at the power stand located within the predetermined distance.

6. The power transmission control device according to claim 2, wherein the identification information includes information on a power company with which the power stand is affiliated.
